(19) United States
(12) Patent Application Publication
(10) Pub. No.: US 2006/0060819 A1
(43) Pub. Date: Mar. 23, 2006

(54) Composition of dentifrice

(76) Inventor: Choong-Hyun Jung, Gwangju (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/500,007

(22) PCT Filed: Dec. 23, 2002
(86) PCT No.: PCT/KR02/02416

§ 371 Date: Sep. 19, 2005

(30) Foreign Application Priority Data
Dec. 24, 2001 (KR) 10-2001-0083982

(51) Int. Cl. C11D 3/39

(52) U.S. Cl. 252/186.38

(57) ABSTRACT

The present invention relates to a dentifrice composition, more particularly to a dentifrice composition that is very effective in decoloring teeth, in eliminating plaque, and in preventing periodontal diseases. For this, the dentifrice composition of the present invention consists of a first paste containing hydrogen peroxide and a second paste containing sodium hypochlorite, wherein the first paste and the second pastes are filled into a dual container with a partition or separate containers.

### TECHNICAL FIELD

The present invention relates to a composition of dentifrice, and more particularly to a composition of dentifrice that achieves significant effects for tooth bleaching and preventing dental caries and periodontal diseases.

Generally, the causes of the discoloration of teeth can be categorized as extrinsic and intrinsic. The extrinsic discoloration may be caused when food residues, nicotine, coffee, black tea, etc. deposit on the surface of teeth, or when the dental tartar or soft deposition on the dental surface is dyed by the ingredients of coloring matter. The intrinsic discoloration may be caused when teeth lose nerves thereof or a person takes too many antibiotics of the tetracycline line, or due to aging.

In order to discoloration of tooth by such causes or initially lackluster teeth, tooth bleaching has been typically used.

One of the tooth bleaching methods is performed in the following order: first, rubber dams are installed around the teeth to be bleached; second, the periphery of the teeth is sealed by dental floss silk to protect gums from being hurt by strong bleaching agents; third, a tool such as a small iron is applied on each of the teeth after painting a reagent on the teeth; and last, the temperature of the iron is elevated depending on the condition of the person. The above method is performed for about an hour, and causes side effects such as the teeth, after being bleached, are over-sensitive to temperature changes.

Accordingly, a tooth bleaching method was developed for bleaching teeth more efficiently by applying heat and light to entire teeth, using a lamp. This method, however, also needs installation of the rubber dams around each of the teeth to be bleached like the aforementioned tooth bleaching method, and one difficulty of this method is that the person must sit in front of a hot lamp for about thirty minutes to an hour.

From the bleaching tooth of heating or irradiating ultraviolet rays or laser beams on the bleaching agent, the inventor has found that the fundamental principle of dental decoloration is to generate oxygen from the bleaching agent.

Meanwhile, a conventional dentifrice for bleaching teeth has been available for dental decoloration that physically abrades and smoothens dental surfaces because the dentifrice contains agents of high abrasive material to achieve the bleaching effect. The dentifrice of such capabilities, however, cannot fully meet user's expectations for decoloring his/her teeth, and also leads to hypersensitive teeth or results in the cervical abrasion of tooth due to excessive abrasion if the dentifrice is used for a long time.

The inventor thus devised a formulation that can bleach tooth without the difficulty and side-effects found in the above dental decoloration method and also without side-effects such as abraded teeth caused by the conventional dentifrice for tooth bleaching.

Common dental diseases include dental caries (causing tooth decay and thereby forming cavities), periodontitis (gingival diseases, periodontal disease) and malocclusion, which are called the three major dental diseases.

Foods causing dental caries include purified foods with no self-purification (e.g., confectionaries, coke, soft drink, hamburgers made with ground meat), foods with a high sugar content (e.g., chocolates, candies, dried fruits), and sticky foods (snacks) which are likely to remain between the teeth or gums because of their adhering properties.

The aforementioned foods causing dental caries adhere to the tooth surface to form a bacteria collection (dental plaques), allowing bacteria to proliferate, and the resulting acid discharged from the bacteria causes teeth to decay.

Persons older than their mid twenties and thirties decreasingly suffer from the dental caries, but increasingly suffer from periodontitis.

Periodontal diseases are infective diseases that adults suffer from frequently, which cause the loss of teeth due to gingival bleeding, swelling, formation of periodontal pocket and destroyed alveolar bones. The invasion mechanism of the periodontal diseases is described below.

Dental plaques mechanically accumulated in periodontal pocket provide bacteria living around the periodontal pocket with a favorable environment. Such inhabitation of bacteria gradually transforms from an aerobic, permeable gram-positive bacteria into an anaerobic gram-negative bacteria, which in turn propagates into deep portions of the periodontal pocket. In this case, all of the toxins and products of the proliferating anaerobic gram-negative bacteria directly destroy tissue, or stimulate the immune system to cause the periodontal tissue to be destroyed in addition to causing inflammation by various actions of the stimulated immune system.

According to statistics, three out of four lost teeth result from periodontal diseases. It is generally regarded that nine out of ten adults suffer from periodontal diseases worldwide, in terms of dentistry. A person suffering from such periodontal diseases has a toothache and difficulty in chewing, and accompanied by a very faulty odor. Gums of the person may bleed or the teeth of the person may sensitive from the resorption of alveolar bones.

Therefore, the periodontal diseases occupy large portions of oral diseases in adults. One factor causing the periodontal diseases is also bacteria in a mouth in which the bacteria collects on the tooth surface (plaque).

As such, a fundamental way to prevent the periodontal diseases and dental caries consists in removing the dental plaque.

Since the bacteria collections adhere to the tooth surface in the form of a thin film, good tooth brushing can remove quite a portion of the plaque, but it is impossible to completely remove it only by toothbrushing if the dental plaque exists on the portions where a toothbrush can not reach.

Therefore, the remaining dental plaque on there parts of teeth combines with inorganic substances in saliva in a mouth to change into dental calculus which can be as hard as stone.

The dental calculus has a rough surface that allows the plaque to easily adhere to, thus causing the plaque to be continuously accumulated to develop into inflammation on gums and to further destroy supporting organizations such as alveolar bones.

### DISCLOSURE OF INVENTION

The invention is designed to solve the aforementioned problems. Therefore, it is an object of the invention to provide a composition of dentifrice that can bleach tooth in an easy way without sideeffects such as the abrasion of teeth.

It is another object of the invention to provide a composition of dentifrice that has a significant effect in preventing dental caries and periodontal diseases.

In order to achieve the object of the invention as described above, a dentifrice composition for bleaching the teeth comprises a first paste containing peroxide, and a second paste containing catalyst having chloric acid ion for activating the peroxide. The peroxide of the present invention comprises one or more peroxides selected from the group consisting of hydrogen peroxide, barium peroxide, sodium perborate, calcium peroxide and urea peroxide. And the catalyst of the present invention comprises one or more catalysts selected from the group consisting of sodium hypochlorite(NaOCl), sodium chlorite(NaOCl₂), sodium chlorate(NaClO₃), calcium hypochlorite(CaCl₂O₂), calcium chlorate(CaCl₂O₆), magnesium chlorate(MgCl₂O₆), aluminum chlorate(AlCl₃O₉) and potassium chlorate(ClKO₃).

And also, the dentifrice composition according to the invention comprises a first paste containing hydrogen peroxide and a second paste containing sodium hypochlorite. Hydrogen peroxide of approximately 2.5×10⁻⁴ to 1.5% by weight of the first paste is contained in the first paste, and the sodium hypochlorite of approximately 2.5×10⁻⁴ to 0.25% by weight of the second paste in the second paste. Then the first paste and the second paste are mixed approximately one to one by weight for the use of dentifrice, the first and second pastes being filled into a dual container with a partition or separate containers.

### BRIEF DESCRIPTION OF THE DRAWINGS

These and other features, aspects, and advantages of the present invention will be apparent from the following description, appended claims, and accompanying drawings. In the drawings:

FIG. 1 shows a color reading graph of an experimental group according to one embodiment of the invention;

FIG. 2 shows a color reading graph of an experimental group according to another embodiment of the invention;

FIG. 3 shows a color reading graph of a control group according to a conventional composition of toothpaste;

FIG. 4 shows a gingival index graph of the experimental group according to one embodiment of the invention;

FIG. 5 shows a gingival index graph of the experimental group according to another embodiment of the invention;

FIG. 6 shows a gingival index graph of the control group according to the conventional composition of toothpaste;

FIG. 7 shows a plaque index graph of the experimental group according to one embodiment of the invention;

FIG. 8 shows a plaque index graph of the experimental group according to another embodiment of the invention; and

FIG. 9 shows a plaque index graph of the control group according to the conventional composition of toothpaste.

### BEST MODE FOR CARRYING OUT THE INVENTION

Hereinafter, preferred embodiments of the present invention will be described in detail with reference to the accompanying drawings.

The composition of dentifrice according to the invention comprises a first paste containing hydrogen peroxide in a dentifrice base and a second paste containing sodium hypochlorite in a dentifrice base.

The hydrogen peroxide H₂O₂ is a chemical substance widely used in producing bleaching agent, oxidizers, derivatives, etc. The bleaching is achieved by means of nascent oxygen generated from unstable chemical substances. However, the hydrogen peroxide itself is a very stable material with little decomposition. In order to decompose the hydrogen peroxide, it is required to expose the hydrogen peroxide to organic matter or heavy metals, apply heat or irradiate with ultraviolet rays or light of short waves such as laser beams.

Accordingly, in order to generate nascent oxygen from the hydrogen peroxide, the sodium hypochlorite NaOCl that serves as a catalyst is added to the second paste to be used in this invention.

The sodium hypochlorite is an alkali salt very effective for sterilization, disinfection and bleaching, with excellent prolonged effects, and can be used as a sterilizing agent, a bleaching agents, an oxidizer and an analytical reagent. In a dental clinic, the sodium hypochlorite is used to disinfect inside of the root canals of teeth, since the sodium hypochlorite has powerful disinfecting capability and, as a powerful organic dissolvent, also removes remaining decaying dental pulp by pervading every part of root canals of teeth where a tool cannot reach.

In the present invention, both of the sodium hypochlorite and the hydrogen peroxide are used together to take advantage of the sterilizing capability and the property of dissolving organic substances of the sodium hypochlorite and the disinfecting and decoloring effect of the hydrogen peroxide.

The chemical reaction is described below when the sodium hypochlorite and the hydrogen peroxide are used together.
NaOCl+H₂O₂--->NaCl+H₂O+O₂

That is, as seen from the above chemical formula, the hydrogen peroxide can generate oxygen through chemical reaction with the sodium hypochlorite without applying heat, ultraviolet rays or laser beams thereto as in a conventional manner.

Therefore, when the composition of dentifrice according to the present invention is used, teeth are decolored by means of the oxygen generated through the chemical reaction of the sodium hypochlorite and the hydrogen peroxide. Also, dental plaque can be easily removed by means of the decoloring capability, sterilizing and disinfecting capability, and the property of dissolving organic substances of the sodium hypochlorite and the hydrogen peroxide.

Since the resultant products from the reaction are salt ‘NaCl’ and water ‘H₂O’ as well as oxygen, when the composition of dentifrice according to the invention is used, and the salty water cleans the user's mouth causing a gargling effect.

In addition, the composition of dentifrice according to the invention is filled into a dual container with a partition so that the first paste containing the hydrogen peroxide and the second paste containing the sodium hypochlorite are mixed to achieve the reaction only when the paste are discharged. And, the same amounts of the first paste and the second paste are preferably discharged from the dual container with a partition.

Hereinafter, the present invention is further detailed by means of embodiments and comparative examples.

The composition of dentifrice according to the invention contains hydrogen peroxide of approximately 2.5×10⁻⁴ to 1.5% by weight with respect to the first paste, and the sodium hypochlorite of approximately 2.5×10⁻⁴ to 0.25% by weight with respect to the second paste.

The first paste is a composition containing a specified amount of hydrogen peroxide in the typical composition base of dentifrice, while the second paste is a composition containing a specified amount of sodium hypochlorite in the typical composition base of dentifrice.

The composition of dentifrice according to the invention contains general components such as abrading agents, wetting agents, foaming agents, bonding agents, flavoring agents, sweetening agents and other components that are in ointment phase.

The abrading agent is a component to remove the dental plaque by means of frictional force, and may be calcium monohydrogen phosphate, calcium carbonate, aluminum hydroxide, precipitated silica, hydrosilicic acid, etc.

The wetting agent is a component to inhibit the water in the composition of dentifrice from evaporating and thus the composition from being solidified when exposed to the air. One or more forms of multivalent alcohol such as glycerin, sorbitol solution, amorphous sorbitol solution, polyethylene glycol, propylene glycol, etc may be selected and used for the wetting agent.

The foaming agent is a component for emulsifying the water-soluble element with the oil-soluble element and for rinsing the mouth. Anionic or non-ionic surfactant such as lauryl sodium sulfate, N-sodium lauroylsarcosilate, N-long chain acyl glutamate, sucrose fatty ester, polyoxyethylene hydrogenated castor oil, sorbitan fatty acid ester, polyoxyethylene-polyoxypropylene copolymer can be used solely or mixed together.

The bonding agent inhibits phase separation of the composition over time by combining an inorganic powder component insoluble in water and a liquid component, and renders the composition viscous. Sodium carboxymethylcellulose, carrageenan, xanthan gum, polyvinyl pyrrolidone, sodium alginate, other gums can be used for the bonding agent.

The sweetening agent and the flavoring agent can also be used to ensure good taste during toothbrushing and for a freshening aftertaste after toothbrushing. Sodium saccharine, aspartame, stevioside, glycyrrhizine, and so on can be used for the sweetening agent, and the mixtures of peppermint, spearmint oil, menthol, carbon, anethole, oegenol can be used for the flavoring agent.

Other components comprise enzymes such as dextranase, lysozyme chloride, etc.

Table 1 shows the compositions of comparative examples of conventional toothpastes that comprise neither hydrogen peroxide nor sodium hypochlorite, and toothpaste compositions that comprise only one of hydrogen peroxide and sodium hypochlorite. Tables 2 and 3 show the embodiments of the toothpaste compositions that contain both hydrogen peroxide and sodium hypochlorite of the invention.

TABLE 1
Comparative examples of the compositions of conventional
toothpaste and the toothpaste comprising either hydrogen peroxide or
sodium hypochlorite

| | Comp. | Comp. | Comp. | Comp. | Comp. |
|---|---|---|---|---|---|
| Component | Example 1 | Example 2 | Example 3 | Example 4 | Example 5 |
| Sorbitol | 60.00 | 60.00 | 60.00 | 60.00 | 60.00 |
| aqueous | | | | | |
| solution | | | | | |
| (70%) | | | | | |
| Lauryl | 3.00 | 3.00 | 3.00 | 3.00 | 3.00 |
| sodium | | | | | |
| sulfate | | | | | |
| Precipitated | 25.00 | 25.00 | 25.00 | 25.00 | 25.00 |
| silica | | | | | |
| Xanthan | 0.20 | 0.20 | 0.20 | 0.20 | 0.20 |
| gum | | | | | |
| Sodium | 0.20 | 0.20 | 0.20 | 0.20 | 0.20 |
| saccharine | | | | | |
| Flavoring | 1.00 | 1.00 | 1.00 | 1.00 | 1.00 |
| agent | | | | | |
| Hydrogen | — | 1.5 | 0.25 | — | — |
| peroxide | | | | | |
| Sodium | — | — | — | 0.25 | 0.05 |
| hypochlorite | | | | | |

| | |
|---|---|
| Purified | Residuals |
| water | |

TABLE 2
Toothpaste compositions containing hydrogen peroxide with varied wt %

| | | Embodiment | Embodiment | Embodiment | Embodiment |
|---|---|---|---|---|---|
| | Component | 1 | 2 | 3 | 4 |
| First | Sorbitol aqueous | 60.00 | 60.00 | 60.00 | 60.00 |
| Paste | solution (70%) | | | | |
| | Lauryl sodium sulfate | 3.00 | 3.00 | 3.00 | 3.00 |
| | Precipitated silica | 25.00 | 25.00 | 25.00 | 25.00 |
| | Xanthan gum | 0.20 | 0.20 | 0.20 | 0.20 |
| | Sodium | 0.20 | 0.20 | 0.20 | 0.20 |
| | saccharine | | | | |
| | Flavoring agent | 1.00 | 1.00 | 1.00 | 1.00 |
| | Hydrogen peroxide | 1.5 | 0.25 | 0.025 | 0.00025 |
| | Purified water | Residuals | | | |
| Second | Sorbitol aqueous | 60.00 | 60.00 | 60.00 | 60.00 |
| Paste | solution (70%) | | | | |
| | Lauryl sodium sulfate | 3.00 | 3.00 | 3.00 | 3.00 |
| | Precipitated silica | 25.00 | 25.00 | 25.00 | 25.00 |
| | Xanthan gum | 0.20 | 0.20 | 0.20 | 0.20 |
| | Sodium | 0.20 | 0.20 | 0.20 | 0.20 |
| | saccharine | | | | |
| | Flavoring agent | 1.00 | 1.00 | 1.00 | 1.00 |
| | Sodium hypochlorite | 0.025 | 0.025 | 0.025 | 0.025 |

| | |
|---|---|
| Purified water | Residuals |

TABLE 3
Toothpaste compositions containing sodium hypochlorite with varied wt %

| | | Embodiment | Embodiment | Embodiment | Embodiment |
|---|---|---|---|---|---|
| | Component | 5 | 6 | 7 | 8 |
| First | Sorbitol aqueous | 60.00 | 60.00 | 60.00 | 60.00 |
| Paste | solution (70%) | | | | |
| | Lauryl sodium sulfate | 3.00 | 3.00 | 3.00 | 3.00 |
| | Precipitated silica | 25.00 | 25.00 | 25.00 | 25.00 |
| | Xanthan gum | 0.20 | 0.20 | 0.20 | 0.20 |
| | Sodium | 0.20 | 0.20 | 0.20 | 0.20 |
| | saccharine | | | | |
| | Flavoring agent | 1.00 | 1.00 | 1.00 | 1.00 |
| | Hydrogen peroxide | 0.025 | 0.025 | 0.025 | 0.025 |
| | Purified water | Residuals | | | |
| Second | Sorbitol aqueous | 60.00 | 60.00 | 60.00 | 60.00 |
| Paste | solution (70%) | | | | |
| | Lauryl sodium sulfate | 3.00 | 3.00 | 3.00 | 3.00 |
| | Precipitated silica | 25.00 | 25.00 | 25.00 | 25.00 |
| | Xanthan gum | 0.20 | 0.20 | 0.20 | 0.20 |
| | Sodium saccharine | 0.20 | 0.20 | 0.20 | 0.20 |
| | Flavoring agent | 1.00 | 1.00 | 1.00 | 1.00 |
| | Sodium hypochlorite | 0.25 | 0.05 | 0.02 | 0.00025 |

| | |
|---|---|
| Purified water | Residuals |

The following test was performed to measure the efficacy of the toothpaste compositions according to the embodiments and comparative examples.

The tests were carried only with the composition of toothpaste. However, the compositions of liquid dentifrice, powdered dentifrice, creamy dentifrice, and solid dentifrice can also be used as a dentifrice for bleaching tooth for the present invention.

[Test]

Forty adults who have ordinary oral conditions with dental caries and gingival disease were selected. Sixteen persons were in their thirties, sixteen persons in their forties, and eight persons in their fifties.

For the test, these persons brushed their teeth three times a day according to their usual brushing habit, each time using 1.5 g of the toothpaste compositions of the embodiments and comparative examples.

Tables 4 to 8 show the average values of color reading, gingival index, and plaque index of those forty adults who used the toothpaste compositions of the comparative examples 1 to 5 for three months.

Tables 9 to 16 show the average values of color reading, gingival index, and plaque index of those forty adults who used the toothpaste compositions of the embodiments 1 to 8 for three months.

Color reader CR-10 from MINOLTA was used for measuring the color reading values.

Higher values of color reading mean the whiter teeth. Therefore, the comparison of the initial color reading value with the color reading value after using toothpaste compositions according to the embodiments shows the effect of the toothpaste compositions of the present invention on the decoloration of teeth.

Gingival index, GI among the above clinical indices was measured by a method such as that of Loe & Silness, etc.

The values of gingival index are classified as the followings:

0=normal gingiva.

1=minor inflammation, slight color change, minor edema, no bleeding when palpated.

2=medium level of inflation, flushing, edema and planing, bleeding when palpated.

3=severe inflammation, distinct flushing and edema, ulcer, spontaneous bleeding.

The value of the gingival index is related to the diversity of clinical gingivitis. Further, the index can be used to determine the prevalence rate and the severity of the gingivitis in epidemiological survey and also to estimate the dental arch of a person.

The plaque index, PI among the above clinical indexes was measured by a method such as that of Loe & Silness, etc.

The values of plaque index are classified as the followings:

0=no dental plaque around gingiva.

1=plaque film around free gingiva and vicinity of tooth; Dental plaque is perceived only by a probe.

2=medium accumulation of soft deposits on the periodontal pocket, gum ridge, or neighboring teeth surface, and can be examined with the unaided eye.

3=abundant deposits on the periodontal pocket, gum ridge, or neighboring teeth surface.

TABLE 4
Test result of toothpaste composition according to the
comparative example 1

| | Initial | | | |
|---|---|---|---|---|
| | state | I month use | 2 month use | 3 month use |
| Color Reading, CR | 63.56 | 63.75 | 63.66 | 64.46 |
| Gingival Index, GI | 1.76 | 1.76 | 1.74 | 1.75 |
| Plaque Index, PI | 1.80 | 1.83 | 1.85 | 1.84 |

TABLE 5
Test result of toothpaste composition according to the
comparative example 2

| | Initial | | | |
|---|---|---|---|---|
| | state | I month use | 2 month use | 3 month use |
| Color Reading, CR | 62.50 | 63.0 | 63.8 | 64.2 |
| Gingival Index, GI | 1.71 | 1.69 | 1.70 | 1.72 |
| Plaque Index, PI | 1.84 | 1.87 | 1.86 | 1.85 |

TABLE 6
Test result of toothpaste composition according to the
comparative example 3

| | Initial | | | |
|---|---|---|---|---|
| | state | I month use | 2 month use | 3 month use |
| Color Reading, CR | 63.6 | 63.7 | 63.6 | 63.9 |
| Gingival Index, GI | 1.67 | 1.69 | 1.65 | 1.70 |
| Plaque Index, PI | 1.82 | 1.80 | 1.84 | 1.84 |

TABLE 7
Test result of toothpaste composition according to the
comparative example 4

| | Initial | | | |
|---|---|---|---|---|
| | state | I month use | 2 month use | 3 month use |
| Color Reading, CR | 62.3 | 62.0 | 62.3 | 62.5 |
| Gingival Index, GI | 1.71 | 1.62 | 1.54 | 1.46 |
| Plaque Index, PI | 1.84 | 1.67 | 1.49 | 1.37 |

TABLE 8
Test result of toothpaste composition according to the
comparative example 5

| | Initial | | | |
|---|---|---|---|---|
| | state | I month use | 2 month use | 3 month use |
| Color Reading, CR | 63.4 | 63.7 | 63.2 | 63.5 |
| Gingival Index, GI | 1.70 | 1.73 | 1.49 | 1.50 |
| Plaque Index, PI | 1.85 | 1.80 | 1.70 | 1.60 |

TABLE 9
Test result of toothpaste composition according to the embodiment 1

| | Initial | | | |
|---|---|---|---|---|
| | state | I month use | 2 month use | 3 month use |
| Color Reading, CR | 62.3 | 64.2 | 66.7 | 69.0 |
| Gingival Index, GI | 1.71 | 1.54 | 1.32 | 1.14 |
| Plaque Index, PI | 1.85 | 1.40 | 0.92 | 0.73 |

TABLE 10
Test result of toothpaste composition according to the embodiment 2

| | Initial | | | |
|---|---|---|---|---|
| | state | I month use | 2 month use | 3 month use |
| Color Reading, CR | 63.5 | 64.7 | 67.3 | 69.5 |
| Gingival Index, GI | 1.70 | 1.52 | 1.37 | 1.12 |
| Plaque Index, PI | 1.83 | 1.57 | 1.40 | 0.92 |

TABLE 11
Test result of toothpaste composition according to the embodiment 3

| | Initial | | | |
|---|---|---|---|---|
| | state | I month use | 2 month use | 3 month use |
| Color Reading, CR | 64.2 | 65.4 | 66.0 | 66.7 |
| Gingival Index, GI | 1.82 | 1.67 | 1.54 | 1.45 |
| Plaque Index, PI | 1.86 | 1.79 | 1.60 | 1.50 |

TABLE 12
Test result of toothpaste composition according to the embodiment 4

| | Initial | | | |
|---|---|---|---|---|
| | state | I month use | 2 month use | 3 month use |
| Color Reading, CR | 64.2 | 63.9 | 64.2 | 64.0 |
| Gingival Index, GI | 1.77 | 1.70 | 1.82 | 1.75 |
| Plaque Index, PI | 1.80 | 1.72 | 1.69 | 1.75 |

TABLE 13
Test result of toothpaste composition according to the embodiment 5

| | Initial | | | |
|---|---|---|---|---|
| | state | I month use | 2 month use | 3 month use |
| Color Reading, CR | 62.3 | 66.4 | 67.8 | 68.0 |
| Gingival Index, GI | 1.71 | 1.54 | 1.32 | 1.14 |
| Plaque Index, PI | 1.85 | 1.45 | 1.19 | 0.73 |

TABLE 14
Test result of toothpaste composition according to the embodiment 6

| | Initial | | | |
|---|---|---|---|---|
| | state | I month use | 2 month use | 3 month use |
| Color Reading, CR | 63.5 | 64.7 | 66.5 | 67.2 |
| Gingival Index, GI | 1.70 | 1.54 | 1.49 | 1.34 |
| Plaque Index, PI | 1.83 | 1.21 | 0.80 | 0.75 |

TABLE 15
Test result of toothpaste composition according to the embodiment 7

| | Initial | | | |
|---|---|---|---|---|
| | state | I month use | 2 month use | 3 month use |
| Color Reading, CR | 63.4 | 64.2 | 64.4 | 65.0 |
| Gingival Index, GI | 1.82 | 1.69 | 1.54 | 1.40 |
| Plaque Index, PI | 1.86 | 1.78 | 1.63 | 1.60 |

TABLE 16
Test result of toothpaste composition according to the embodiment 8

| | Initial | | | |
|---|---|---|---|---|
| | state | I month use | 2 month use | 3 month use |
| Color Reading, CR | 63.6 | 63.9 | 63.8 | 63.7 |
| Gingival Index, GI | 1.77 | 1.79 | 1.72 | 1.74 |
| Plaque Index, PI | 1.80 | 1.80 | 1.82 | 1.79 |

Hereinafter, the effects of the control groups of tables 4 to 8 (when the toothpaste compositions according to the comparative examples 1 to 5 are used) and the experimental groups of tables 8 to 16 (when the toothpaste compositions according to the embodiments 1 to 8 are used) are compared through graphs.

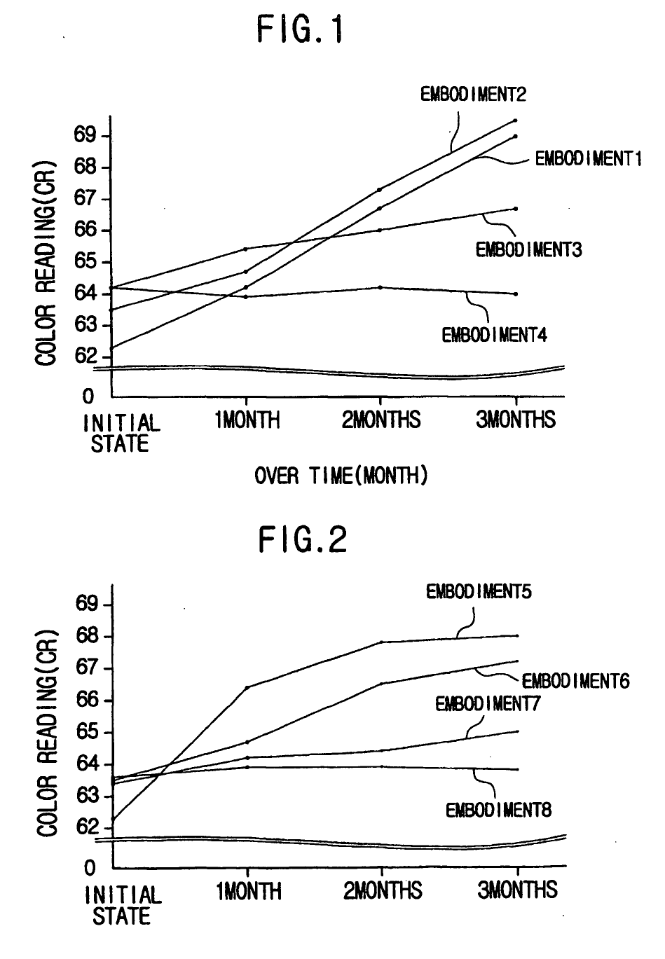

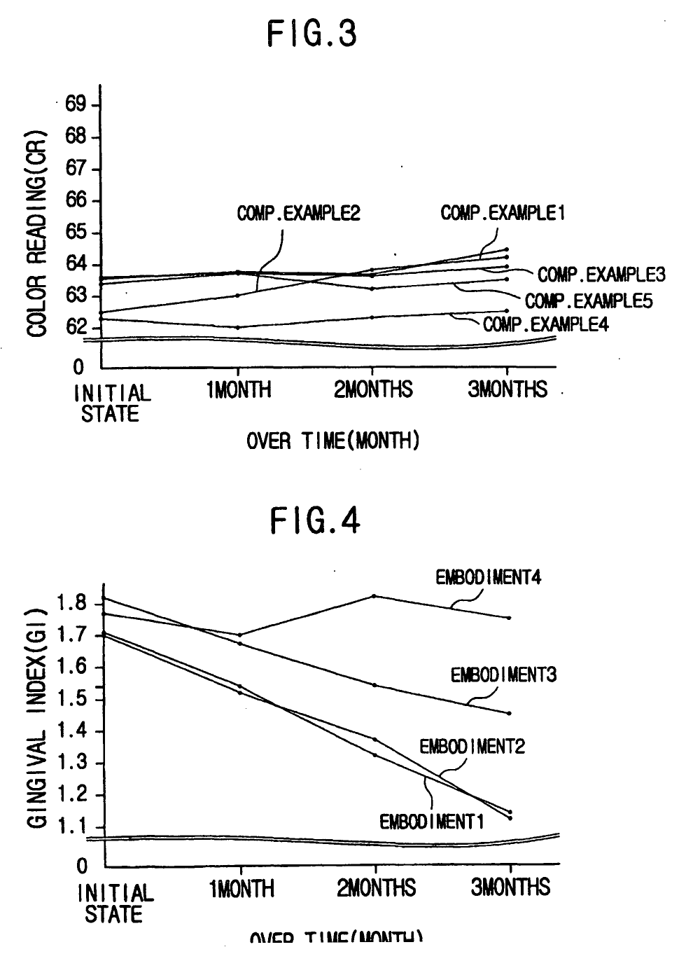

FIG. 1 shows a graph of color readings of an experimental group according to one embodiment of the present invention, FIG. 2 shows a graph of color readings of an experimental group according to another embodiment of the present invention, and FIG. 3 shows a graph of color readings of a control group according to conventional compositions of toothpaste.

As shown in FIG. 3, the changes in color readings of toothpaste compositions of comparative examples 1 to 5 that include neither hydrogen peroxide nor sodium hypochlorite, or those that include only one of hydrogen peroxide and sodium hypochlorite, are relatively small. The color reading value of the comparative example 2 is a little bit increased, but the increase is very small as compared with the toothpaste composition of experimental groups according to the present invention.

In the mean time, in the toothpaste compositions of embodiments 1 to 4, the color reading values of embodiments 1 to 3 are largely increased, however, the color reading value of embodiment 4 is rarely changed, as shown in FIG. 1. From this fact, it can be seen that the hydrogen peroxide content under 0.025% by weight has almost no effect on decoloration of tooth.

Also, in the toothpaste compositions of embodiments 5 to 8, the color reading values of embodiments 5 to 7 are largely increased, however, the color reading value of embodiment 8 is rarely changed, as shown in FIG. 2. From this fact, it can be seen that the sodium hypochlorite content under 0.00025% by weight has almost no effect on decoloration of tooth.

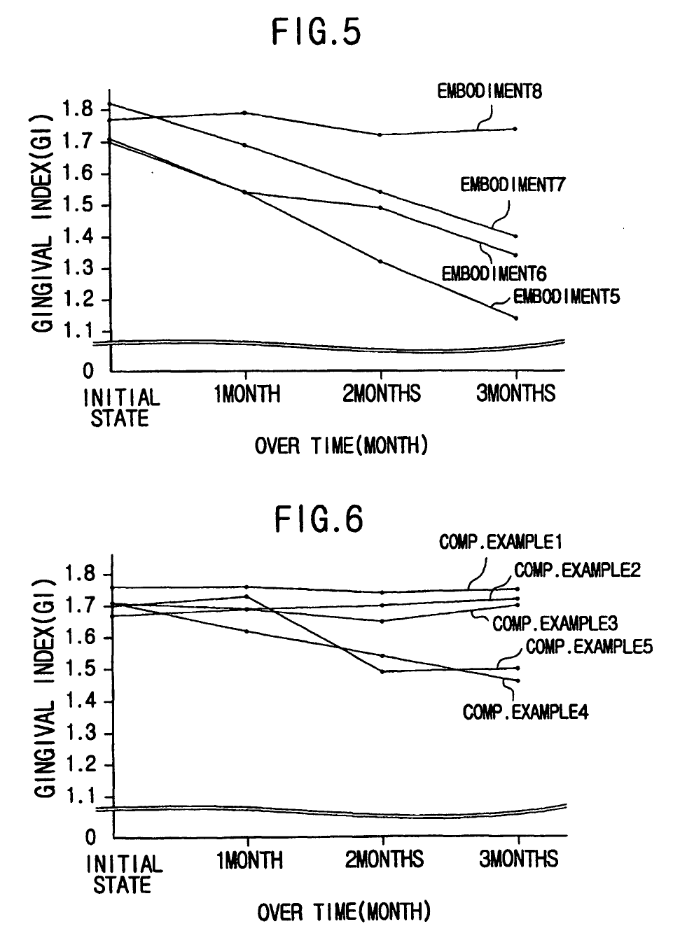

FIG. 4 shows a graph of gingival indices of the experimental group according to one embodiment of the invention, FIG. 5 shows a graph of gingival indices of the experimental group according to another embodiment of the invention, and FIG. 6 shows a graph of gingival indices of the control group according to the conventional compositions of toothpaste.

As shown in FIG. 6, the changes in the gingival indexes of toothpaste compositions of comparative examples 1 to 5 that include neither hydrogen peroxide nor sodium hypochlorite, or that include only one of hydrogen peroxide and sodium hypochlorite, are relatively small.

In the mean time, in the toothpaste compositions of embodiments 1 to 4, the gingival indices of embodiments 1 to 3 are largely decreased, however, the gingival index of embodiment 4 is rarely changed, as shown in FIG. 4. From this fact, it can be seen that the hydrogen peroxide content under 0.025% by weight has almost no effect on prevention and cure of periodontal diseases.

Also, in the toothpaste compositions of embodiments 5 to 8, the gingival indices of embodiments 5 to 7 are largely decreased, however, the gingival index of embodiment 8 is rarely changed, as shown in FIG. 5. From this fact, it can be seen that the sodium hypochlorite content under 0.00025% by weight has almost no effect on prevention and cure of periodontal diseases.

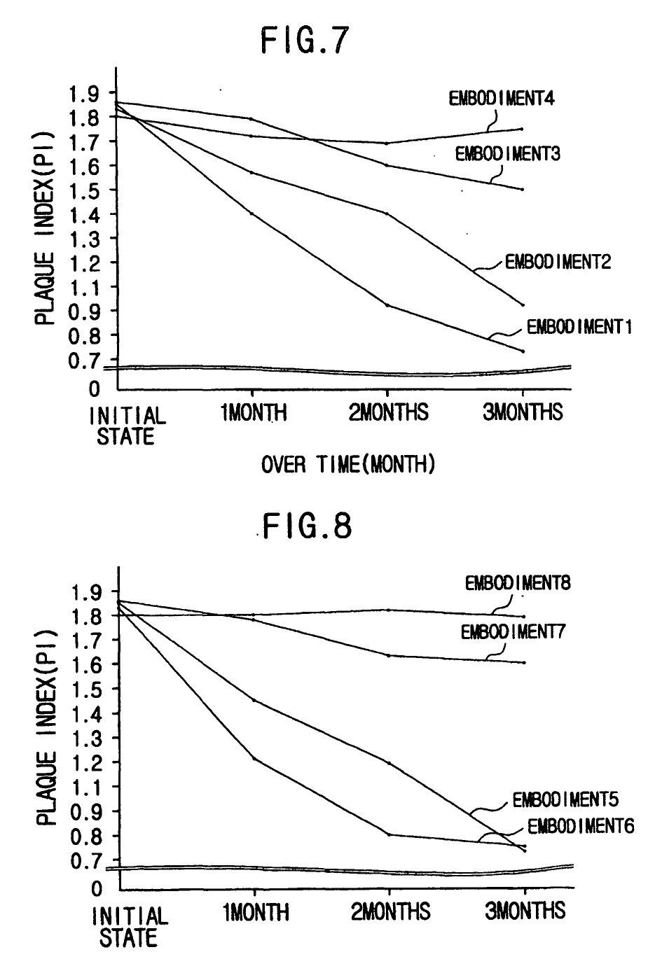

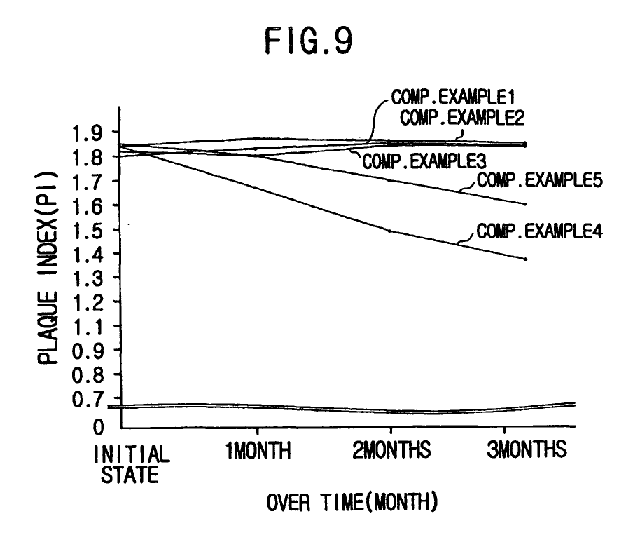

FIG. 7 shows a graph of the plaque indices of the experimental group according to one embodiment of the invention, FIG. 8 shows a graph of the plaque indices of the experimental group according to another embodiment of the invention, and FIG. 9 shows a graph of the plaque indices of the control group according to the conventional compositions of toothpaste.

As shown in FIG. 9, the changes in the plaque indices of toothpaste compositions of comparative examples 1 to 5 that include neither hydrogen peroxide nor sodium hypochlorite, or that include only one of hydrogen peroxide and sodium hypochlorite, are relatively small.

In the mean time, in the toothpaste compositions of embodiments 1 to 4, the plaque indices of embodiments 1 to 3 are largely decreased, however, the plaque index of embodiment 4 is rarely changed, as shown in FIG. 7. From this fact, it can be seen that the hydrogen peroxide content under 0.025% by weight has almost no effect on prevention and cure of dental caries.

And also, in the toothpaste compositions of embodiments 5 to 8, the plaque indices of embodiments 5 to 7 are largely decreased, however, the plaque index of embodiment 8 is rarely changed, as shown in FIG. 8. From this fact, it can be seen that the sodium hypochlorite content under 0.00025% by weight has almost no effect on prevention and cure of dental caries.

There are few changes in color reading, gingival index, and plaque index when conventional toothpaste composition was used for 3 months. When hydrogen peroxide was added to the paste, there were slight increases in the color reading value, but little change in gingival index and plaque index. When only sodium hypochlorite was added to the paste, there were slight decreases in gingival index and plaque index, but little change in the color reading value.

On the contrary, when the toothpaste compositions according to the present invention were used for 3 months, the color reading was remarkably increased, and the gingival index and the plaque index were largely decreased. However, when the hydrogen peroxide and the sodium hypochlorite contents in the first and the second pastes are under 0.00025% by weight of the first paste and the second pastes respectively, the changes were small.

In the mean time, when the toothpaste composition whose hydrogen peroxide content is above 1.5% by weight of the first paste is used, it can cause pain in the user's gingiva. And when the toothpaste composition whose sodium hypochlorite content is above 0.25% by weight of the second paste is used, the toothpaste has a very unpleasant odor.

Therefore, it is preferable for the toothpaste composition of the present invention to contain hydrogen peroxide about 2.5×10⁻⁴ to 1.5% by weight of the first paste and to contain sodium hypochlorite about 2.5×10⁻⁴ to 0.25% by weight of the second paste.

As described hereinabove, the present invention provides a dentifrice composition that can decolor teeth simply without side effects such as the abrasion of teeth.

Further, the present invention provides a dentifrice composition which has a powerful decoloring effect.

Furthermore, the present invention provides a dentifrice composition that has a remarkable effect in restraining dental caries and periodontal diseases.

In addition, the present invention provides a dentifrice composition that has a gargling effect by salty water, the resultant products from the reaction between hydrogen peroxide and the sodium hypochlorite.

The present invention has been described in detail. However, it should be understood that the detailed description and specific examples, indicating preferred embodiments of the invention, are given by way of illustration only, and accordingly various changes and modifications within the spirit and scope of the invention will become apparent to those skilled in the art from this detailed description.

In the claims, any reference signs placed between parentheses shall not be construed as limiting the claim. Use of the verb “comprise” and its conjugations does not exclude the presence of elements or steps other than those stated in a claim.

1. A dentifrice composition for bleaching the teeth comprising: a first paste containing peroxide; and a second paste containing catalyst having chloric acid ion for activating said peroxide.

2. The dentifrice composition for bleaching the teeth according to claim 1, wherein said peroxide comprises one or more peroxides selected from the group consisting of hydrogen peroxide, barium peroxide, sodium perborate, calcium peroxide and urea peroxide.

3. The dentifrice composition for bleaching the teeth according to claim 1, wherein said catalyst comprises one or more catalysts selected from the group consisting of sodium hypochlorite(NaOCl), sodium chlorite(NaOCl₂), sodium chlorate (NaCl0₃), calciumhypochlorite (CaCl₂O₂), calciumchlorate (CaC1₂0₆), magnesiumchlorate (MgCl₂0₆), aluminum chlorate (AlCl₃0₉) and potassiumchlorate (ClKO₃).

4. The dentifrice composition for bleaching the teeth according to claim 1, wherein said peroxide is hydrogen peroxide (H₂0₂); and said catalyst is sodium hypochlorite(NaOCl).

5. The dentifrice composition for bleaching the teeth according to claim 4, wherein the hydrogen peroxide is included from about 2.5×10⁻⁴ to 1.5% by weight of the first paste.

6. The dentifrice composition for bleaching the teeth according to claim 4, wherein the sodium hypochlorite is included from about 2.5×10⁻⁴ to 0.25% by weight of the second paste.

7. The dentifrice composition for bleaching the teeth according to claim 1, wherein the first paste and the second paste are mixed in the ratio of about 1:1 by weight when the composition is used.

8. The dentifrice composition for bleaching the teeth according to claim 7, wherein the first paste and the second pastes are filled into a dual container with a partition or separate containers.

9. The dentifrice composition for bleaching the teeth according to claim 1, wherein the composition comprises one or more dentifrices selected from the group consisting of liquid dentifrice, powdered dentifrice, creamy dentifrice, and solid dentifrice.
